(19) United States
(12) Patent Application Publication
(10) Pub. No.: US 2021/0064030 A1
(43) Pub. Date: Mar. 4, 2021

(54) DRIVER ASSISTANCE FOR A VEHICLE AND METHOD FOR OPERATING THE SAME

(71) Applicants: Yu-Sian Jiang, Austin, TX (US); Mu-Jen Huang, Taipei (TW)

(72) Inventors: Yu-Sian Jiang, Austin, TX (US); Mu-Jen Huang, Taipei (TW)

(21) Appl. No.: 16/551,741

(22) Filed: Aug. 27, 2019

(51) Int. Cl. G05D 1/00; G08G 1/01; G05D 1/02; B60W 40/08

(52) U.S. Cl. CPC G05D 1/0088; G08G 1/0125; G05D 1/0212; B60W 40/08; B60W 2550/20; B60W 2040/0872; B60W 2420/42; B60W 2540/22; G05D 2201/0213

(57) ABSTRACT

A driver assistance system for a vehicle is provided. The driver assistance system includes an input interface, a sensing unit, and a processing unit. The input interface is configured to receive at least one input signal from a driver. The sensing unit is configured to detect a traffic condition. The processing unit is configured to perform the following instructions. The input signal is obtained when the vehicle is traveling along a route. A driver's intention is estimated according to the input signal. An en-route goal is determined according to the driver's intention and the traffic condition. The route is updated according to the en-route goal.

### FIELD

The present disclosure generally relates to a driver assistance for a vehicle, and a method for operating the same.

### BACKGROUND

A vision for an autonomous-driving vehicle is that a passenger specifies a global destination and the vehicle autonomously maneuvering to that destination, namely it's the solution for end-to-end autonomy. This vision, however, does not consider the dynamic driver preference of en-route destination, particularly the waypoint changing, i.e., situations in which a driver wishes to modify the destination during ongoing autonomous service. For instance, when the driver or passenger wishes to modify the destination when the passenger happens to notice a restaurant through the vehicle's window and would like a prompt pull over; the driver or passenger would need to either respecify the destination using a keyboard, or disengage the autonomous driving agent to take over steering and manually drive there. If the system is not explicitly designed to accommodate this scenario, destination re-specify may be too difficult; or the human is not able to quickly instruct the vehicle, it may end up passing by the desired destination. When the en-route destination is a waypoint for complying driver's intention or preference, the change of the en-route destination becomes even harder. For example, the driver may prefer to route through from the left side of an obstacle rather from the right side. The system needs to be able to respect driver's intention and change the navigation path to comply with. Therefore, it is desirable to provide a new way for planning a route when the driver intends to change the en-route destination during driving.

### SUMMARY

In one aspect of the present disclosure, a driver assistance system for a vehicle is provided. The driver assistance system includes a driver interface, a sensing unit, and a processing unit. The driver interface is configured to receive at least one input signal from a driver. The sensing unit is configured to detect a traffic condition. The processing unit is configured to perform the following instructions. The input signal is obtained when the vehicle is traveling along a route. A driver's intention is estimated according to the input signal. An en-route goal is determined according to the driver's intention and the traffic condition. The route is updated according to the en-route goal.

In another aspect of the present disclosure, a method of operating a driver assistance system for a vehicle is provided. The method includes the following actions. A driver interface obtains at least one input signal when the vehicle is traveling along a route. A processing unit estimates a driver's intention according to the input signal. The processing unit determines an en-route goal according to the driver's intention and the traffic condition. The processing unit updates the route according to the en-route goal.

### BRIEF DESCRIPTION OF THE DRAWINGS

FIG. 1 is a block diagram of a driver assistance system for a vehicle according to an implementation of the present disclosure.

FIG. 2 is a schematic diagram showing the front view of the vehicle interior according to an implementation of the present disclosure.

FIG. 3 is a flowchart of a method for operating a driver assistance system for a vehicle according to an embodiment of the present disclosure.

FIG. 4 is a schematic diagram of the gaze tracking technique according to an implementation of the present disclosure.

FIG. 5 is a schematic diagram illustrating the planning of the updated route according to an embodiment of the present disclosure.

FIG. 6 is a schematic diagram illustrating the planning of the updated route according to another embodiment of the present disclosure.

FIG. 7 is a schematic diagram illustrating the planning of the updated route according to yet another embodiment of the present disclosure.

FIG. 8 is a flowchart a method for operating a driver assistance system for a vehicle according to another embodiment of the present disclosure.

FIG. 9 is a schematic diagram illustrating the updating of the en-route goal according to an embodiment of the present disclosure.

### DETAILED DESCRIPTION

The following description contains specific information pertaining to exemplary implementations in the present disclosure. The drawings in the present disclosure and their accompanying detailed description are directed to merely exemplary implementations. However, the present disclosure is not limited to merely these exemplary implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

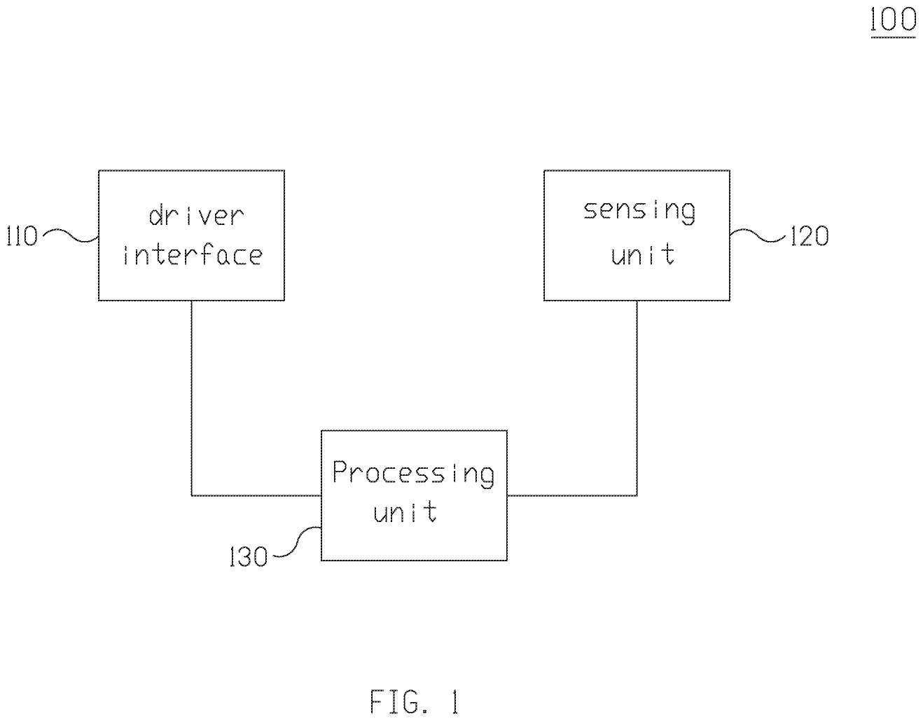

FIG. 1 is a block diagram of a driver assistance system 100 for a vehicle according to an implementation of the present disclosure. The driver assistance system 100 includes a driver interface 110, a sensing unit 120, and a processing unit 130. The driver interface 110 is configured to receive at least one input signal from a driver. In one embodiment, the input signal from the driver interface includes a biological signal of the user. For instance, the biological signal may include, but not limited to, an image, a gaze, a gesture, a head pose, a sound, a voice, a speech, a heart rate, a breath or the combination of the above. In one implementation, the driver interface 110 is coupled to an image capturing unit capable of capturing images of the user. The image capturing unit may be a depth-sensing camera with a depth sensor. The camera may be an RGB color camera or an infrared (IR) camera. In some embodiments, the image capturing unit further includes a light source (e.g., an IR LED) enabling instant profiling of the body or skeleton of the user. With the light source and high dynamic range (HDR) imaging, the image recognition may be adapted to a darker environment. In another implementation, the driver interface 110 is coupled to a microphone configured to record the sound, voice or speech of the user. In some other implementations, the driver interface 110 is coupled to a heart rate monitor configured to detect the heart rate of the user.

In another embodiment, the driver interface 110 may be coupled to a driver monitoring system (DMS) to receive the driver's signal including driver face detection, eye status, fatigue level, gaze vector, gaze point, attention status (on-road or off-road), distraction status, driver presence, and/or driver identity.

In another embodiment, the input signal includes a vehicle control signal, or said, driving command. For instance, the vehicle control signal may include, but not limited to, a steering wheel control signal, a blinker signal a gas pedal or throttle signal, a brake signal, a gear-shift signal, or other driving command signals. The driver interface 110 may be configured to couple with the vehicle ECU or the OBD (on-board diagnostics) port of a vehicle to acquire the vehicle control signals.

In another embodiment, the input signal includes a vehicle status signal. For instance, the vehicle status signal may include the wheel angle, vehicle velocity, engine speed, tire pressure, and other vehicle parameters. The driver interface 110 may be configured to couple with the vehicle ECU to acquire the vehicle status signals.

In yet another embodiment, the driver interface 110 is coupled to an electronic device to receive data or instructions. For instance, the electronic device may include, but not limited to, a button, a knob, a touch panel, a keyboard, a tablet, a voice receiving/recognition device, or a cell phone.

The sensing unit 120 is configured to detect a traffic condition. The sensing unit 120 may be arranged around the vehicle capable of sensing surrounding objects and road context. For instance, it may be disposed, depending on the design and application, at the front part, the rear part, the left side, the right side, the left-rear side, and/or the right-rear side of the vehicle. In one implementation, the sensing unit 120 may include an image capturing unit (e.g., camera) capable of capturing images of the front and rear view of the vehicle (digital video recorders, DVR), or the surrounding view of the vehicle (Around View Monitor, AVM). The sensing unit 120 may be a depth-sensing camera with a depth sensor. The camera may be an RGB color camera or an infrared (IR) camera. In some embodiments, the sensing unit 120 further includes a light source (e.g., an IR LED or a visible light illuminator) enabling instant profiling of the surrounding environment. With the light source and high dynamic range (HDR) imaging, the image recognition may be adapted to a darker environment. In another implementation, the sensing unit 120 further includes a Lidar system. In some other implementations, the sensing unit 120 further includes a radar system and/or the ultrasonic sensors in the front and rear bumper.

The traffic condition may include, but not limited to, information about an object, an obstacle, a vehicle, a pedestrian, a traffic signal, a traffic sign, a speed limit, a road, a lane, an intersection, current traffic flow, a traffic context, and rules of the road. The information may be a point cloud from the lidar, the obstacle distance, speed from the radar, an image from the camera, a classification from an image, or a vector map from the fusion of the sensors.

The processing unit 130 is coupled to the driver interface 110, and the sensing unit 120. The processing unit 130 may process the input signals, data and instructions. In one embodiment, the processing unit 130 may be a hardware module comprising one or more central processing unit (CPU), microcontroller(s), ASIC, or a combination of above but is not limited thereof. In one embodiment, the processing unit 130 is one of the functional modules of an automotive electronic control unit (ECU).

The processing unit 130 may perform image recognition signal processing, data fusion, path planning, and vehicle control. In one embodiment, the processing unit 130 is configured to analyze the captured images received via the driver interface 110, and perform facial detection, facial expression recognition, head pose detection, gaze detection/tracking, point of interest recognition, body skeleton recognition, gesture recognition, and/or other biometric recognitions on the captured images. In some embodiments, the processing unit 130 further performs voice recognition, speech recognition, or natural language processing based on the recorded voice or speech. In some other embodiments, the processing unit 130 further monitors or determines a status such as driver fatigue, distraction, and attention based on the biological signal received via the driver interface 110.

In yet another embodiment, the processing unit 130 analyzes the images captured and/or the sensed data by the sensing unit 120, and performs object detection or recognitions on the captured images and/or sensed data.

In some embodiments, the processing unit 130 analyzes the data from LiDAR, radar, and ultrasonic sensors to generate the point cloud, vector map, and cost map of the vehicle surroundings. In one implementation, the processing unit 130 further calculates the statuses, the directions, distance, and/or the velocities of the sensed objects.

In some embodiments, the processing unit 130 fuses the homogeneous or heterogeneous data from the driver interface 110 and/or the sensing unit 120 to generate the context of the driver status and the traffic condition. The driver context may be the driver's fatigue level, cognition load, distraction status, and the traffic condition context may be the traffic congestion, the safety region of instant traffic, and the predictive vector map, but is not limited thereof.

In some embodiments, the processing unit 130 determines the point-of-interest (POI) of a driver according to the gaze vector and gaze point. In one implementation, the processing unit 130 further estimates the driver intention according to the POI and/or driver's signals from the driver interface 110.

In some embodiments, the processing unit 130 determines the en-route goal or destination according to the driver intention.

In some embodiments, the processing unit 130 provides path planning and controls the vehicle's motion according to the en-route goal or destination.

In some other embodiments, the driver assistance system 100 further includes an audible unit configured to warn, notify or acknowledge the driver regarding the creation or update of the en-route goal.

In some other embodiments, the driver assistance system 100 further includes a wireless communication unit configured to communicate with a server, internet, or other portable devices.

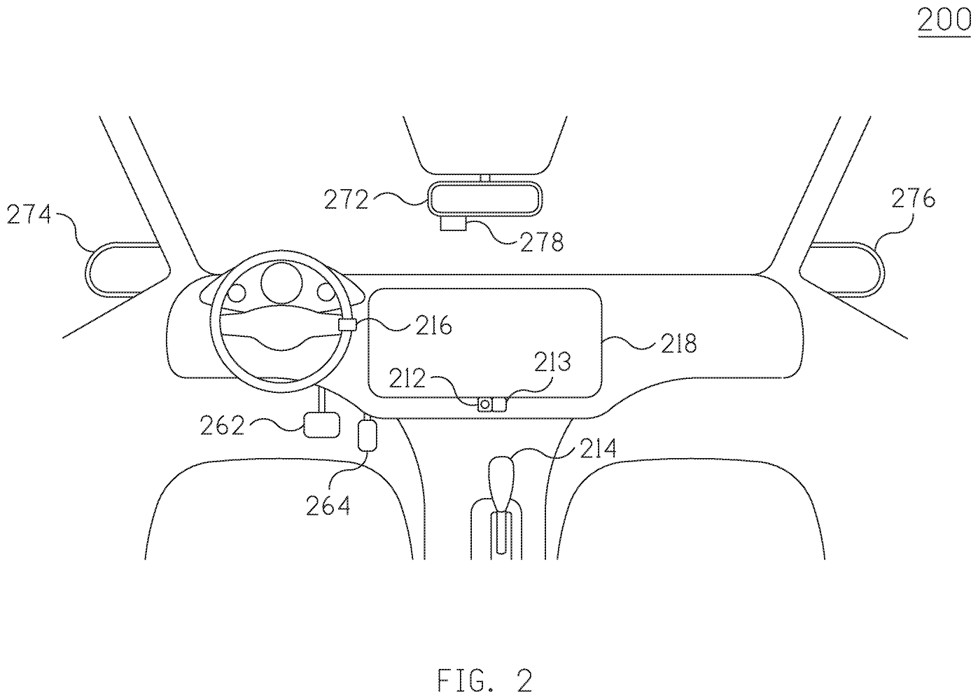

FIG. 2 is a schematic diagram showing the front view of the vehicle interior 200 according to an implementation of the present disclosure. In this implementation, the vehicle is a car. However, in other implementations, the vehicle could be any kinds of motor vehicle, such as motorcycles, buses, off-road vehicles, light trucks and regular truck. The driver interface 110 is configured for receiving the vehicle status signals and driver's signals. The vehicle status signals such as vehicle speed and wheel angles may be obtained from the vehicle ECU or OBD2. The driver's signals may include driver's command and driver's monitoring signals. The driver's command may further include driver's vehicle control signals and driver's instructions to the devices coupled to the driver interface. As shown in FIG. 2, the driver interface (not shown) is coupled to a camera 212 with a light source 213 to obtain driver's images and/or videos. The camera 212 (plus optionally, the light source 213) may be a driver monitoring system (DMS) for detecting driver's fatigue, distraction, gaze point, face expression, face appearance, and driver identity. The driver interface is coupled to a ECU to receive the driver's vehicle control signal such as a gear-shift signal 214, a blinker signal 216 of a left turn or a right turn, a steering wheel signal for the steering angle signal, a brake signal 262 and a gas pedal signal 264. Optionally, the driver interface is coupled to an infotainment system 218 or other devices to receive/transmit data or instructions from/to the driver. Besides, the driver interface may receive the vehicle status signals such as a velocity signal, a wheel angle signal, a tire pressure signal, or other vehicle parameterized signals. On the other hand, the sensing unit (not shown) may be arranged around the vehicle. For instance, it may be disposed, depending on the design and application, at the front part, the rear part, the left side, the right side, the left-rear side, and/or the right-rear side of the vehicle. It should be noted that, the arrangements of the driver interface, the camera 212, and the sensing unit are not limited thereto.

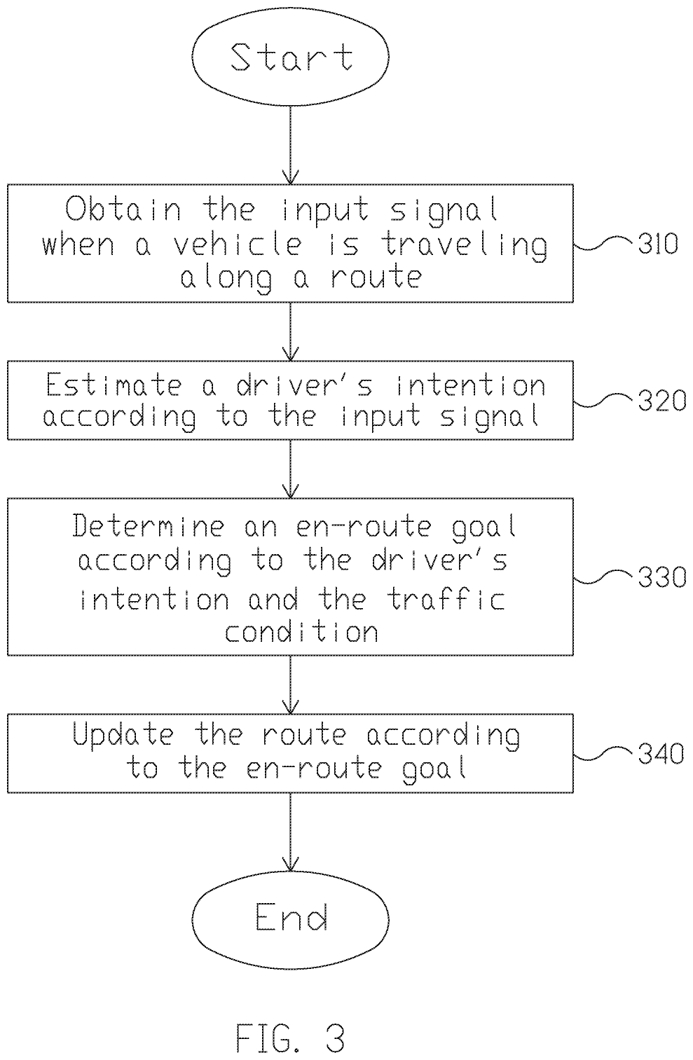

FIG. 3 is a flowchart of a method for operating a driver assistance system for a vehicle according to an embodiment of the present disclosure. The method includes the following actions. In action 310, the driver interface obtains at least one input signal from a driver interface when a vehicle is traveling along a route. In one embodiment, the input signal may be directly entered or explicitly commanded by the driver. In another embodiment, the input signal may be obtained by monitoring the driver. In another embodiment, the input signal may be obtained from the vehicle control or status signals. As stated above, the at least one input signals may include, but not limited to, a biological signal, such as an image, a gaze, a gesture, a head pose, a sound, a voice, a speech, a heart rate, a breath or the combination of the above, a vehicle control or status signal, e.g., a steering wheel control signal, a left turn signal, a right turn signal, a gas pedal signal, a brake signal, a velocity signal, an acceleration signal, a gear-shift signal, or other driving behavior signals, and data or instructions from driver's command entered from a button, a knob, a touch panel, a keyboard, a tablet, a cell phone, or other devices.

In action 320, the processing unit estimates a driver's intention according to the input signal. In one embodiment, the driver's intention may be implicitly or explicitly estimated according to various types of the input signals. In one implementation, the driver's intention includes a specific destination. The specific destination is a specific position in the global or local map coordinates. In another implementation, the driver's intention includes a driving task, such as pullover, lane-changing, and parking. For instance, when the driver gives a direct command by speech, such as “stop by a supermarket” or “pull over”, the driver's intention could be explicitly estimated as “stop by a supermarket” or “pull over” according to the plain meaning of the language. In another case, when the driver issues a left turn signal by the blinker, the driver's intention could be estimated as “turn left” or “switch to the left lane”. On the other hand, when the driver says, “I'm hungry”, the driver's intention might be implicitly estimated as “find a restaurant” or “find a drive-through”. In an embodiment, the driver's intention is predefined and classified in a primitive motion set. The processing unit estimates the driver's intention according to the input signal and traffic condition by selecting at least one instruction from the primitive motion set. The instruction of the primitive motion set may include, but not limited to, lane keeping, lane changing, adaptive cruise, parking, takeover. The processing unit may further convert the instruction to a waypoint or an en-route goal according to the traffic condition and context. Finally, the en-route goal is converted into the vehicle commands to the actuators of the vehicle.

In another embodiment, the driver intention may be regarded as a vehicle control takeover between vehicle autonomy and manual driving. For example, when a driver distraction or sleeping is detected by the DMS (driver monitoring system), the driver's intention may be presumed as continuing the driving task autonomously, e.g. keeping the lane.

In action 330, the processing unit determines an en-route goal according to the driver's intention and a traffic condition. As mentioned above, the traffic condition may include, but not limited to, information about an object, an obstacle, a vehicle, a pedestrian, a traffic signal, a traffic sign, a speed limit, a road, a lane, an intersection, current traffic flow, a congestion of the traffic, and rules of the road. The object information may include object type (static or dynamic), object class (e.g. vehicle, pedestrian), the distance, coordinate, size, shape, and the velocity of the object. In one implementation, the en-route goal may be a location. The location could be a specific position in the global or local map coordinates. For instance, the en-route goal is a destination if the driver intention refers to a specific location such as a restaurant. In another implementation, the en-route goal is a waypoint for a task. For instance, when the driver's intention is to stop by a supermarket when the driver is driving on the way home, the en-route goal is determined to be the least detour-taking supermarket on the planned route home. In another case, when the driver's intention is to pull over, the en-route goal is determined to be the nearest space for parking at the side of the road. In yet another case, when the driver's intention is to switch lane, the processing unit identifies the information of the current driving lane of the vehicle, and/or the nearby vehicles or objects, and determines whether it is feasible or safe to switch lane, and thus sets the en-route goal as “switching lane” or “switching lane before/after a specific time”. Similarly, when the driver's intention is to turn right/left, the processing unit identifies the information of the current driving lane of the vehicle, rules of the driving road, and/or the nearby vehicles, pedestrian or objects and sets the en-route goal as “turn right/left at which intersection”. In some other cases, when the driver's intention is to find a coffee shop, the processing unit obtains a map and the search result for the nearest coffee shop, and then set the en-route goal as the “Starbucks on 5th Avenue”. Alternatively, the processing unit may perform object detection on captured image of the surrounding environment, recognizes on the McDonald's sign on the side of the road, and set it as the en-route goal.

In action 340, the processing unit updates the route according to the en-route goal. The updated route is planned in response to the traffic condition and the en-route goal. For instance, the processing unit keep tracking the nearby obstacles including predicting the movement of the nearby obstacles, and detecting the road signs, lanes, and navigation map for estimating the ego lane, and updates the route such that the vehicle achieves the en-route goal without colliding with any obstacles or violating the traffic rule. In addition, the processing unit further obtains or constructs geographic information, a map, a HD map. In this case, the processing unit may provide precisely control over the vehicle with motion parameters such as throttle, brake, steering angle, and blinker.

In some embodiments, the processing unit further provides an autonomous driving module for vehicle control. The control of the vehicle may be a blending result of shared autonomy. The shared autonomy takes command from both human driver and autonomous module and blend the commands to determine the commands for controlling the vehicle. When a driver's intention is estimated and inferred, the en-route goal is determined, and thus the according planned path and vehicle commands are generated. On the contrary, when the driver intention is null (no intention is inferred), the vehicle respects mainly from the autonomous driving system or the driver's direct control command. For example, if the vehicle is under an autonomous mode such as adaptive cruise control (ACC) on the highway, the vehicle returns to ACC mode when a driving task such as a car taking over is completed by the driver's intention. Another example is that, if the vehicle is under the manual driving mode, the vehicle is switched to manual driving mode when a driving task such as a lane changing is completed by the driver intention. In such a case, the lane changing according to the en-route goal may avoid the collision by interfering time of lane changing to comply with the safety constraint.

As a result, the driver assistance system estimates the driver's intention and provides the updated route such that that the operation could be smoothly executed, and thus enables a more efficient communication between the driver and the vehicle. On top of that, there are more advantages such as the time efficiency of arrival, and less fluctuation the vehicle speed undergoes.

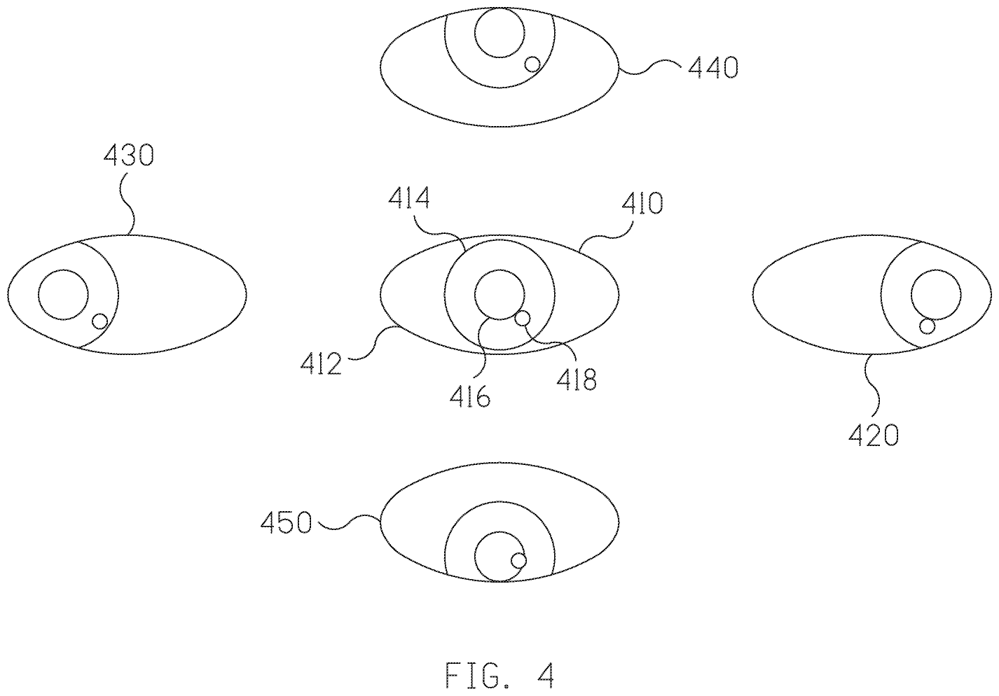

A few more examples about how the drive's intention is estimated are described below. In one implementation, the driver's intention is estimated according to the gaze of the driver monitored continuously during driving. For example, the images or videos of the driver are captured, and the images and videos are also captured from the road camera (e.g. 278 as shown in FIG. 2). The processing unit performs gaze tracking on the captured images to monitor the gaze vector of the driver, and thus computes the gaze trajectory. The processing unit further computes the coordinate and perspective transformation to locate the gaze vector onto specific gaze point on the road camera plane of the road scene. The gaze point is correlated with the detected objects in the road scene image. Throughout the probability distribution of the object over the gaze trajectory, the system may determine the point of interest (POI) such that the POI becomes an input for estimating the driver intention. FIG. 4 is a schematic diagram of the gaze tracking technique according to an implementation of the present disclosure. In the present disclosure, the gaze point refers to where a person is looking at. Specifically, a light source (e.g., 213 as shown in FIG. 2) emits infrared (IR) light, and the IR light is reflected in the eyes and captured by a camera (e.g., 212 as shown in FIG. 2), and the gaze vector of a person is calculated based on the position of the reflection in the eyes, and the positions of the pupil and iris. For instance, as shown in FIG. 4, when a person is looking ahead, an eye image 410 is captured and an eye contour 412, an iris contour 414, a pupil contour 416 and a reflection (glint) 418 are identified. On the other hand, when the person is looking right, left, up or down, the eye image 420, 430, 440 or 450 are captured respectively, and thus the positions of the reflection, iris, and/or the pupil may be changed. Accordingly, since the positions of the camera and the light source are known, based on the changing of the relative position between the iris, pupil, and the reflection, the gaze vector of the person is calculated. Afterwards, based on the captured images or videos of the environment, the object recognition is performed on the road scene image, and thus the object/location the driver is looking at is identified and estimated as the driver's intention. Comparing with the traditional system that use the keyboard to input destination, using gaze tracking to detect the driver's intention have more benefit. For example, the proposed driver assistance system utilizing gaze tracking leads to a higher success rate of identifying the correct destination than the traditional system. One reason is that the user may not have enough time to key in the address before the vehicle passes by. In contrast, the human could shift their gaze and the shift could be immediately detected. A second reason is to resolve the destination ambiguity. It might be difficult for the user to specify a location without knowing the specific address or the location. However, by using the gaze, the spatial position corresponding to the user gaze behavior could be obtained easily and therefore the location is identified correctly. Additionally, it is also faster and safer for the driver to convey his/her intention while driving through gaze than inputting messages to the system.

Moreover, the driver's intention is estimated according to an interest point of the driver, where the interest point of the driver is detected according to the gaze of the driver. A dynamic interest point detection (DIPD) technique (proposed by Y.-S. Jiang, G. Warnell, and P. Stone, “DIPD: Gaze-based intention inference in dynamic environments,” 2018) may be utilized to recognize the user's intended destination based on the monitored gaze. The DIPD is a technique for inferring the interest point corresponding to the human's intent from eye-tracking data and an environment video. Since the driver's intention is estimated during driving, which happens in a highly dynamic environment, the DIPD technique correlates the road scene with the human's gaze point to infer the human's interest point and deals with various sources of errors such as eye blinks, high-speed tracking misalignment, and shaking video content. These advantages make DIPD useful for vehicle applications.

In another implementation, the driver's intention is estimated according to a status of the driver, where the status of the driver is identified according to a biological signal. As discussed above, the biological signal may include, but not limited to, an image, a gaze, a gesture, a head pose, a sound, a voice, a speech, a heart rate, a breath or the combination of the above. For example, the processing unit identifies the facial and gaze signals of the driver and determines whether the driver is intrigued by a certain location. Also, the processing unit determines whether the driver is distracted or drowsy by monitoring the gaze, eye status, breath, heart rate, and thus the driver's intention is estimated accordingly.

In another implementation, the driver's intention is estimated according to the voice of the driver. For instance, a microphone is adapted to record the voice or speech of the driver. The processing unit may perform voice recognition and/or speech recognition to recognize the context of the voice or speech and determine the driver's intention accordingly.

In yet another implementation, the driver's intention is estimated according to a vehicle control signal or a vehicle status signal. For instance, the driver's intention is estimated by a vehicle motion status (e.g., switch lanes to the left/right, turn left/right, speed up, slow down, control the velocity) according to a steering wheel control signal, a left turn signal, a right turn signal, a gas pedal signal, a brake signal, a gear-shift signal. Moreover, according to the vehicle control signal, the processing unit detects a motion parameter so as to precisely estimate the driver's intention. The motion parameter includes, for example, the speed, acceleration, steering angle and rate, and also executing time of each control instruction.

In some implementations, the driver's intention is acknowledged according to some other input signals from other devices such as a button, a touch panel, a keyboard, a tablet, a cell phone, or a voice command. For example, the system may output the estimated intention and ask for driver's confirmation by a visual or voice heads up. The driver may acknowledge it by pressing a predefined button or a voice command, for triggering a path planning for an en-route goal accordingly.

On top of that, the driver's intention is estimated according to at least two input signals. For instance, the driver's intention is estimated according to the vehicle control signal and the gaze of the driver. Referring back to FIG. 2, when a steering wheel control signal, or a left/right turn signal is issued by the driver, and the processing unit determines that the gaze point of the driver is on the rear-view mirror 272, the left rear-view mirror 274, or the right rear-view mirror 276, the driver's intention is estimated to switch to the left/right lane or turn left/right lane. In another case, when the interest point of the driver is identified as a shop on the right side of the road during driving and the right turn signal or steering wheel control signal is received, the processing unit may determine the interest point of the driver. If a further brake signal is given, the parking task in determined as the driver's intention, and then the system may plan the en-route path for an auto parking to the shop. The en-route may be dynamically updated according to the road context and the driver intention. It is noted that the above scenarios are for illustration purpose only, the estimation of the driver's intention is not limited thereto.

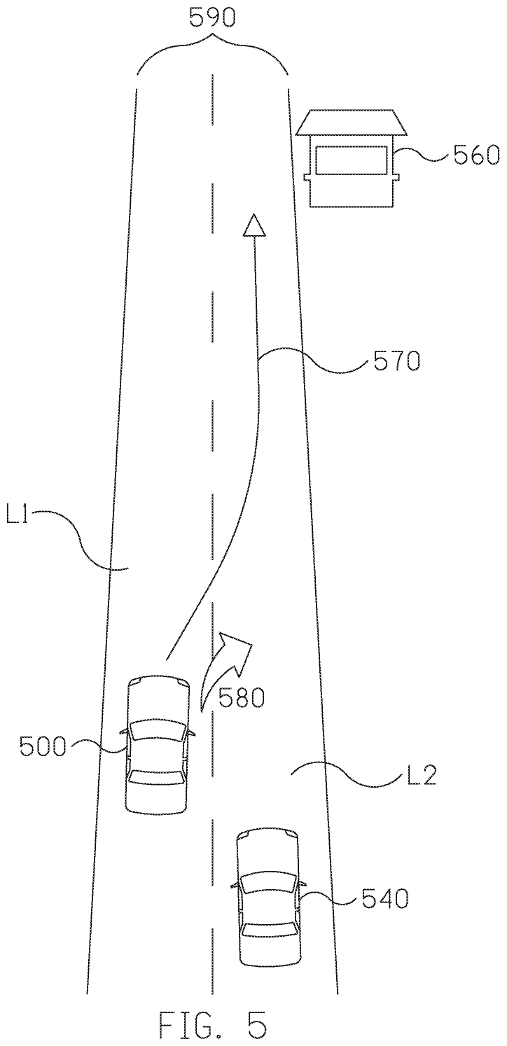

FIG. 5 is a schematic diagram illustrating the planning of the updated route according to an embodiment of the present disclosure. For instance, when the driver is driving on a road 590, the driver's intention is estimated as finding a convenient store and the en-route goal is set as the shop 560 on the right side of the road 590. Meanwhile, based on the detected traffic condition, e.g., the vehicle 500 is traveling in the left lane L1 and the information about nearby vehicle 540, the updated route 570 is planned. Specifically, the processing unit provides a series of instructions to guide the vehicle 500 to travel along the updated route 570, which includes performing lane-changing 580 to the right lane L2 with motion parameter including a specific execution time in order not to collide with the vehicle 540 and then going straight 50 meters and stopping at the side of the road.

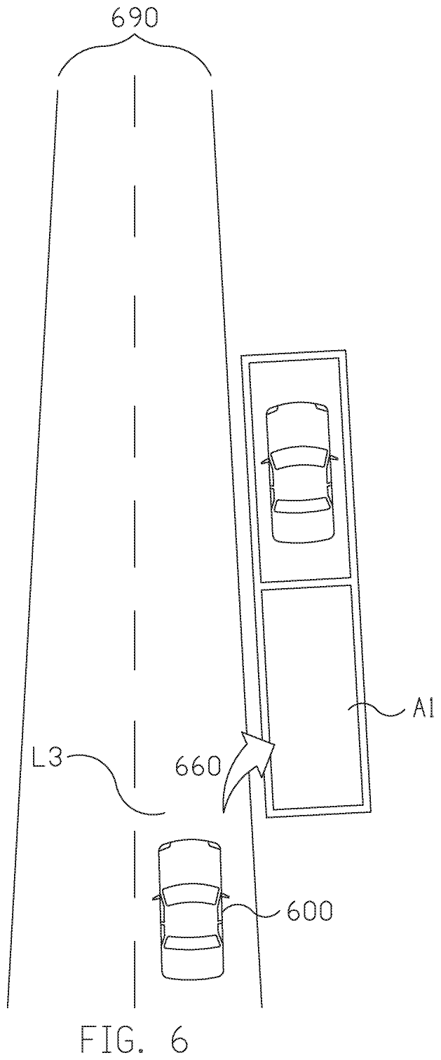

Taking FIG. 6 for another example, when the driver is driving on a road 690, the driver's intention is to find a parking space 660 and parking to the nearest parking space A1 is set as the en-route goal. Based on the detected traffic condition that the vehicle 600 is traveling in the right lane L3, the updated route including a series of instructions to guide the vehicle to park in the space A1 is planned.

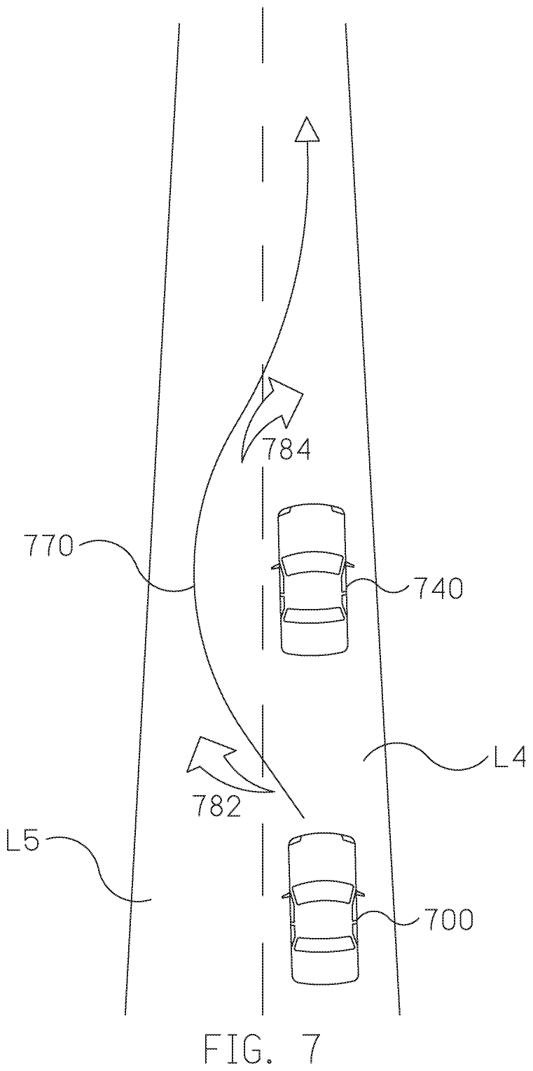

FIG. 7 is a schematic diagram illustrating the planning of the updated route according to another embodiment of the present disclosure. As shown in FIG. 7, in a case that the driver's intention is to take over the car before him/her, and thus passing or overtaking the vehicle 740 is set as the en-route goal. Based on the detected traffic condition, the route is planned such that the vehicle 700 traveling on the lane L4 perform lane-changing 782 to the left lane L5 and then perform lane-changing 784 back to the lane L5.

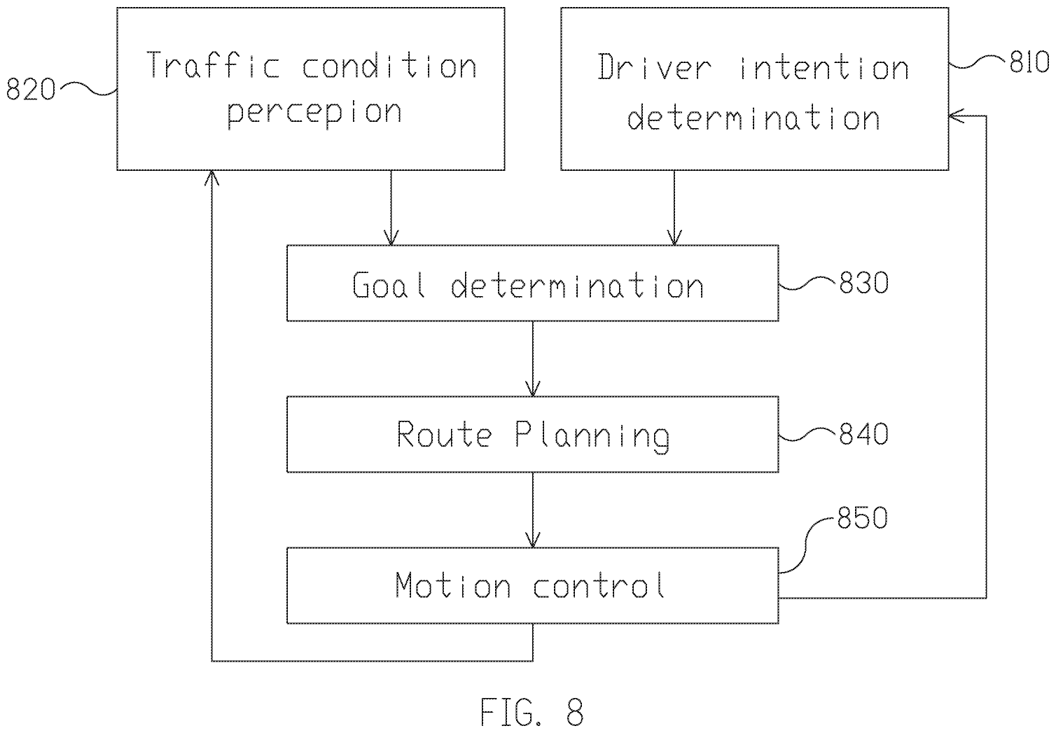

FIG. 8 is a flowchart a method for operating a driver assistance system for a vehicle according to another embodiment of the present disclosure. In this embodiment, the en-route goal could be updated in response to the instant traffic condition and the driver's intention. As shown in FIG. 8, after the traffic condition perception is performed (e.g., in block 820) and the driver's intention is determined (e.g., in block 810), the processing unit determines the en-route goal according to the driver's intention and the traffic condition (e.g., in block 830). For instance, when the driver's intention is going to at a place, the processing unit may calculate the cost function in accordance with efficiency, comfort, and safety constraints, for determining the en-route goal that best meet driver's intention. Based on the en-route goal, the processing unit plans the route (e.g., in block 840), and provides motion control instructions (e.g., in block 850) to guide the vehicle to travel along the route.

Moreover, after the motion control is performed, the processing unit keeps tracking the instant traffic condition (e.g., repeats action 820) and tracking the driver's intention (e.g., repeats action 810) and determines whether to update the en-route goal in response the instant traffic condition and the driver's intention. For example, during traveling along the planned route, the driver's intention had shifted to another one, the processing unit determines whether to update/change the en-route goal to the second target according to, e.g., whether the original target is closer than the second target, whether it is feasible/safe to change to the second target, whether it is urgent to change the goal, whether it is quicker to move to the original target or the second target, or the combination of the above. As a result, there could be no update for the en-route goal at all (i.e., the vehicle will remain on the same route). Alternatively, the en-route goal could be changed/updated to the second target immediately, and therefore a new route is planned, and the original route is abandoned. In another case, the en-route goal could be changed/updated to the second target after arriving the original target, and therefore a new route is planned while the vehicle moves along the original route. In some cases, the en-route goal could be changed/updated to the second target and then to the original target, and therefore a new route is planned accordingly.

On the other hand, since the instant traffic condition may vary, the en-route goal may be updated in response to the instant traffic condition. For instance, during traveling along the planned route, when a change of the traffic condition is detected or a collision is predicted or at a high chance of endangering the safety of the driver and passengers, the processing unit could change/update the en-route goal to avoid the possible accident. In these cases, the en-route goal could be changed/updated to a safer one.

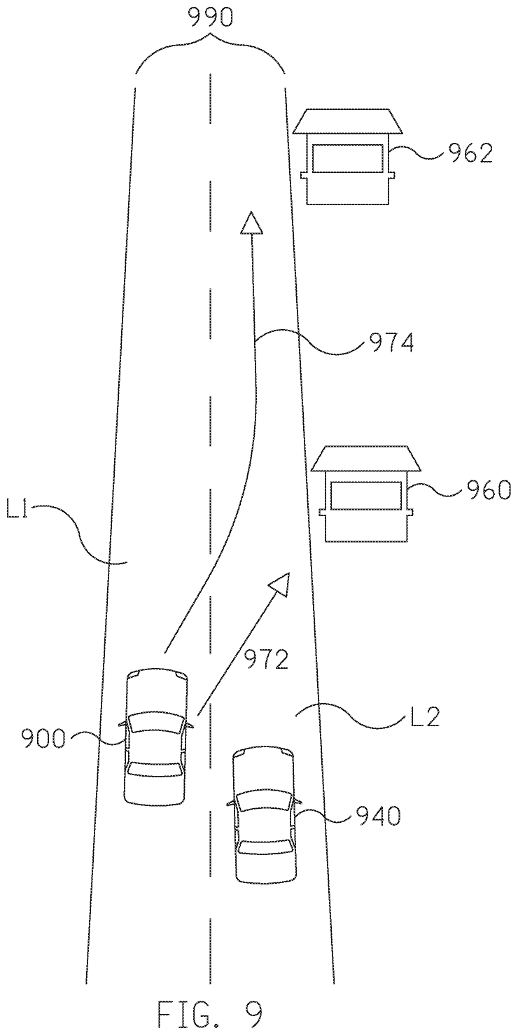

Taking FIG. 9 for example, the vehicle 900 is traveling on the road 990. The en-route goal is determined to be the shop 960, and the route 972 is planned. At the time of the planning, it is feasible and safe to switch lanes from lane L1 to lane L2. However, during the vehicle is moving, the nearby vehicle 940 is approaching such that it is not safe for the driver to switch lanes. As such, the en-route goal is updated to the next shop 962; and thus the updated route 974 is planned. It is noted that these scenarios are for illustration purpose only, the en-route goal determination and the route planning process are not limited thereto.

When driving manually, unskillful drivers may exhibit more oscillatory behavior as they try to determine which controls to apply in order to achieve the intended goal. In contrary, with a model of the vehicle dynamics and explicit knowledge of the goal, the proposed driver assistance system does not suffer from this behavior. Moreover, a faster vehicle speed is achieved than that achieved in the manual driving condition.

In summary, the driver assistance system not only handles low-level vehicle control, but also continuously monitors the driver's intention in order to respond to dynamic changes in desired destination. As a result, the vehicle trajectories have lower variance, the task completion is achieved more quickly, and fewer user actions are required. Moreover, the driver assistance system proposed in the present disclosure is more time and energy efficient, safer, and more comfortable than manual driving.

Based on the above, several driver assistance systems for a vehicle and methods for operating a driver assistance system for a vehicle are provided in the present disclosure. The implementations shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A driver assistance system for a vehicle, comprising:
a driver interface configured to receive at least one input signal from a driver;
a sensing unit configured to detect a traffic condition; and
a processing unit configured to perform instructions for:
obtaining the input signal;
estimating a driver's intention according to the input signal;
determining an en-route goal according to the driver's intention and the traffic condition; and
updating a route according to the en-route goal.

2. The driver assistance system of claim 1, wherein the input signal includes a biological signal of the driver, and the processing unit is further configured to perform instructions for:
identifying a status of the driver according to the biological signal;
wherein the driver's intention is estimated according to the status of the driver.

3. The driver assistance system of claim 2, wherein the biological signal includes a plurality of facial images, and the processing unit is further configured to perform instructions for:
monitoring a gaze of the driver according to the facial images;
detecting an interest point of the driver according to the gaze of the driver;
wherein the driver's intention is estimated according to the interest point of the driver.

4. The driver assistance system of claim 1, wherein the input signal includes a vehicle control signal, and the processing unit is further configured to perform instructions for:
detecting a motion parameter according to the vehicle control signal;
wherein the driver's intention is estimated according to the motion parameter.

5. The driver assistance system of claim 1, wherein the processing unit is further configured to perform instructions for:
recognizing a context of the input signal;
wherein the driver's intention is estimated according to the context of the input signal.

6. The driver assistance system of claim 1, wherein the driver's intention includes a driving task.

7. The driver assistance system of claim 1, wherein the en-route goal includes a location.

8. The driver assistance system of claim 1, wherein the processing unit is further configured to perform instructions for:
tracking the driver's intention when the vehicle is traveling along the updated route; and
determining whether to update the en-route goal according to the driver's intention.

9. The driver assistance system of claim 1, wherein the processing unit is further configured to perform instructions for:
tracking an instant traffic condition when the vehicle is traveling along the updated route; and
determining whether to update the en-route goal according to the instant traffic condition.

10. The driver assistance system of claim 1, wherein the processing unit is further configured to perform instructions for:
providing a series of instructions to guide the vehicle to travel along the updated route.

11. A method for operating a driver assistance system for a vehicle, and the method comprises:
obtaining, by a driver interface, at least one input signal from a driver;
estimating, by a processing unit, a driver's intention according to the input signal;
determining, by the processing unit, an en-route goal according to the driver's intention and a traffic condition; and
updating, by the processing unit, a route according to the en-route goal.

12. The method of claim 11, wherein the input signal includes a biological signal of the driver; and the method further comprises:
identifying, by the processing unit, a status of the driver according to the biological signal;
wherein the driver's intention is estimated according to the status of the driver.

13. The method of claim 12, wherein the biological signal includes a plurality of facial images, and the method further comprises:
monitoring, by the processing unit, a gaze of the driver according to the facial images;
detecting, by the processing unit, an interest point of the driver according to the gaze of the driver;
wherein the driver's intention is estimated according to the interest point of the driver.

14. The method of claim 11, wherein the input signal includes a vehicle control signal, and the method further comprises:
detecting, by the processing unit, a motion parameter according to the vehicle control signal;
wherein the driver's intention is estimated according to the motion parameter.

15. The method of claim 11, further comprising:
recognizing, by the processing unit, a context of the input signal;
wherein the driver's intention is estimated according to the context of the input signal.

16. The method of claim 11, wherein the driver's intention includes finding a driving task.

17. The method of claim 11, wherein the en-route goal includes a location.

18. The method of claim 11, further comprising:
tracking, by the processing unit, the driver's intention when the vehicle is traveling along the updated route; and
determining, by the processing unit, whether to update the en-route goal according to the driver's intention.

19. The method of claim 11, further comprising:
tracking, by the processing unit, an instant traffic condition when the vehicle is traveling along the updated route; and
determining, by the processing unit, whether to update the en-route goal according to the instant traffic condition.

20. The method of claim 11, further comprising:
providing, by the processing unit, a series of instructions to guide the vehicle to travel along the updated route.
